(19) United States
(12) Patent Application Publication
(10) Pub. No.: US 2025/0344678 A1
(43) Pub. Date: Nov. 13, 2025

(54) AIR PUMP PROPELLED AQUARIUM CLEANER

(71) Applicant: John Marsland, Brooklyn, CT (US)

(72) Inventor: John Marsland, Brooklyn, CT (US)

(21) Appl. No.: 18/657,192

(22) Filed: May 7, 2024

(51) Int. Cl. A01K 63/04

(52) U.S. Cl. CPC A01K 63/04

(57) ABSTRACT

An air pump propelled aquarium cleaner to be disposed within an aquarium filled with water and connected to an air pump, such that the air pump propelled aquarium cleaner is propelled by air to move and to clean a bottom of the aquarium.

### BACKGROUND

### 1. Field

The present general inventive concept relates generally to an aquarium cleaner, and particularly, to an air pump propelled aquarium cleaner.

### 2. Description of the Related Art

Routine cleaning of aquariums and fish tanks can be a tedious and messy process often involving manual labor, diverse supplies, and the risk of harming the delicate balance of an aquatic environment.

As consistent cleaning of freshwater or saltwater aquariums is essential to protecting the aquatic animals living within the aquariums, there is a need for a cost-effective and efficient device that provides a constant cleaning of such aquariums.

### SUMMARY

The present general inventive concept provides an air pump propelled aquarium cleaner.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an air pump propelled aquarium cleaner to be disposed within an aquarium filled with water and connected to an air pump to clean a bottom of the aquarium, the air pump propelled aquarium cleaner including a main body, first tracks movably disposed at a first lateral side of the main body, second tracks movably disposed at a second lateral side of the main body, an air receiving tube connected to the main body to receive air from the air pump, an air driven motor connected to the air receiving tube to receive the air therein, the air driven motor including a driving axle connected to the air driven motor to rotate in response to the air driven motor receiving the air from the air receiving tube, and a first driving sprocket disposed at a first end of the driving axle to rotate in response to the rotation of the driving axle, such that the rotation of the driving axle causes the first tracks to move around the first lateral side of the main body, a second driving sprocket disposed at a second end of the driving axle to rotate in response to the rotation of the driving axle, such that the rotation of the driving axle causes the second tracks to move around the second lateral side of the main body, and a fan pump to receive the air from the air receiving tube, the fan pump including a fan disposed at a base portion of the fan pump to rotate in response to receiving the air from the air receiving tube, such that rotation causes debris to be picked up by the fan and directed into the fan pump, a debris outtake hose connected to a top portion of the fan pump at a first end thereof to receive the debris, and a debris outtake disposed at a second end of the debris outtake hose to expel the debris onto a surface of the water.

The air pump propelled aquarium cleaner may further include a plurality of first passive sprockets connected to the first tracks to rotate in response to the movement of the first tracks, such that the plurality of first passive sprockets guide the first tracks around the first lateral side of the main body, and a plurality of second passive sprockets connected to the second tracks to rotate in response to the movement of the second tracks, such that the plurality of second passive sprockets guide the second tracks around the second lateral side of the main body.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates an air pump propelled aquarium cleaner, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the FIGURES, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Air Pump 10
Air Pump Hose 11
Air Pump Propelled Aquarium Cleaner 100
Main Body 110
First Tracks 120
First Passive Sprockets 121
Second Tracks 130
Second Passive Sprockets 131
Air Receiving Tube 140
Air Receiving Tube Intake 141
Air Receiving Tube Outtake 142
Air Driven Motor 150
Driving Axle 151
First Driving Sprocket 152
Second Driving Sprocket 153
Fan Pump 160
Fan 161
Debris Outtake Hose 162
Mesh Filter 163
Debris Outtake 164

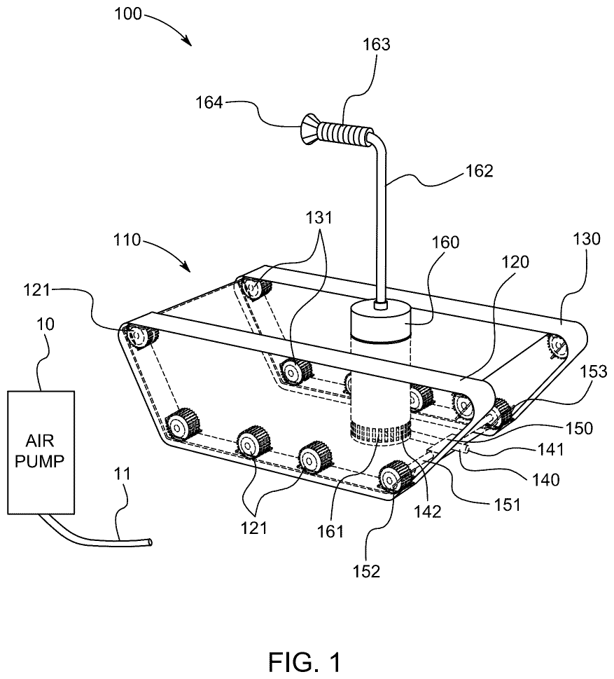

FIG. 1 illustrates an air pump propelled aquarium cleaner 100, according to an exemplary embodiment of the present general inventive concept.

The air pump propelled aquarium cleaner 100, and all components therein and/or connected thereto, may be constructed from at least one of metal, plastic, wood, silicone, glass, and rubber, etc., but is not limited thereto, and can be constructed from any material known to one of ordinary skill in the art.

Referring to FIG. 1, the air pump propelled aquarium cleaner 100 may include a main body 110, first tracks 120, second tracks 130, an air receiving tube 140, an air driven motor 150, and a fan pump 160, but is not limited thereto.

The air pump propelled aquarium cleaner 100 may be shaped somewhat like an army tank, and thus, may include first tracks 120 and second tracks 130 movably disposed on opposite sides of lateral portions of the air pump propelled aquarium cleaner 100, such that the first tracks 120 and the second tracks 130 are movable around the main body 110.

The air receiving tube 140 may be disposed on the main body 110, and may include an air receiving tube intake 141 at a first and of the air receiving tube 140, and an air receiving tube outtake 142 at a second end of the air receiving tube 140, but is not limited thereto.

The air receiving tube intake 141 may be connected to an external air pump 10 via an air pump hose 11 of the air pump 10, such that the air receiving tube 140 receives air from the air pump 10 via the air receiving tube intake 141. The air pump 10 may be a standard air pump known to one of ordinary skill in the art of aquariums.

The air driven motor 150 may include a driving axle 151, a first driving sprocket 152, and a second driving sprocket 153, but is not limited thereto.

The driving axle 151 may include the first driving sprocket 152 disposed at a first end of the driving axle 151, and may include the second driving sprocket 152 disposed at a second end of the driving axle 151.

The first tracks 120 may be connected to first passive sprockets 121 and the first driving sprocket 152, which may be disposed around a first lateral side of the main body.

The second tracks 130 may be connected to second passive sprockets 131 and the second driving sprocket 153, which may be disposed around a second lateral side of the main body.

The air driven motor 150 may be connected to the air receiving tube 140 and the driving axle 151, such that when the air receiving tube 140 receives the air from the air pump 10 via the air receiving tube intake 141, the air receiving tube 140 provides the air to the air driven motor 150, which causes the driving axle 151 to rotate. The air driven motor 150 may include pistons, sprockets, a fan, or any other type of motor known to one of ordinary skill in the art, which can cause the driving axle to rotate.

When the driving axle 151 rotates, the first tracks 120 and the second tracks 130 begin to move, and the first passive sprockets 121 and the second passive sprockets 131, respectively, facilitate the movement of the first tracks 120, such that the entire air pump propelled aquarium cleaner 100 moves.

The fan pump 160 may include a fan 161, a debris outtake hose 162, a mesh filter 163, and a debris outtake 164, but is not limited thereto.

The fan pump 160 may be connected to a second end of the air receiving tube 140, specifically, the air receiving tube outtake 142 that is disposed at the second end of the air receiving tube 140.

The air that is received by the fan pump 160 causes the fan 161 to rotate, causing the fan 161 to churn up debris from a floor of the aquarium, such that the debris is sent upwards through the fan pump, into the debris outtake hose 162, through the mesh filter 163, and out through the debris outtake 164. Any debris expelled from the debris outtake 164 will sit on a surface of the water in the aquarium, and will be picked up by a surface filter (not illustrated). Alternatively, a battery (not illustrated) could power the fan pump 160.

The present general inventive concept may include an air pump propelled aquarium cleaner 100 to be disposed within an aquarium filled with water and connected to an air pump 10 to clean a bottom of the aquarium, the air pump propelled aquarium cleaner 100 including a main body 110, first tracks 120 movably disposed at a first lateral side of the main body 110, second tracks 130 movably disposed at a second lateral side of the main body 110, an air receiving tube 140 connected to the main body 110 to receive air from the air pump 10, an air driven motor 150 connected to the air receiving tube 140 to receive the air therein, the air driven motor 150 including a driving axle 151 connected to the air driven motor 150 to rotate in response to the air driven motor 150 receiving the air from the air receiving tube 140, a first driving sprocket 152 disposed at a first end of the driving axle 151 to rotate in response to the rotation of the driving axle 151, such that the rotation of the driving axle 151 causes the first tracks 120 to move around the first lateral side of the main body 110, a second driving sprocket 152 disposed at a second end of the driving axle 151 to rotate in response to the rotation of the driving axle 151, such that the rotation of the driving axle 151 causes the second tracks 130 to move around the second lateral side of the main body 110, and a fan pump 160 to receive the air from the air receiving tube, the fan pump including a fan 161 disposed at a base portion of the fan pump 160 to rotate in response to receiving the air from the air receiving tube 140, such that rotation causes debris to be picked up by the fan 161 and directed into the fan pump 160, a debris outtake hose 162 connected to a top portion of the fan pump 160 at a first end thereof to receive the debris, and a debris outtake 164 disposed at a second end of the debris outtake hose 162 to expel the debris onto a surface of the water.

The air pump propelled aquarium cleaner 100 may further include a plurality of first passive sprockets 121 connected to the first tracks 120 to rotate in response to the movement of the first tracks 120, such that the plurality of first passive sprockets 121 guide the first tracks 120 around the first lateral side of the main body 110, and a plurality of second passive sprockets 131 connected to the second tracks 130 to rotate in response to the movement of the second tracks 130, such that the plurality of second passive sprockets 131 guide the second tracks 130 around the second lateral side of the main body 110.

A purpose of the air pump propelled aquarium cleaner 100 is to provide users with an effective method of cleaning fish tanks and aquariums to ensure a pristine environment. Ingenious and practical, the air pump propelled aquarium cleaner 100 offers a modern tracked device that efficiently cleans the bottom of any tank and/or body of water without harming water parameters or established ecosystems, allowing for streamlined cleaning management. Expanding on the initial design of the existing air pump that most aquariums utilize, the air pump propelled aquarium cleaner 100 introduces a novel air hose designed to attach to a fitting on the drive axle, propelling the device through different substrates effortlessly. This strategically placed hose vacuums up debris while a macerator pump sends it to a filter located at the water's surface, with the functionality being powered by either battery or air. Additionally, the same air hose that powers the air pump propelled aquarium cleaner 100 also operates a fan with a shroud, serving the same purpose to move debris to the top of the water vessel for quick maintenance and removal via the filter. This innovative, top-quality product takes the hassle out of cleaning an aquarium or fish tank and ensures that cleaning them won't harm water parameters or established ecosystems during the process. As a result, the air pump propelled aquarium cleaner 100 may prove to be essential in the aquatic pet industry.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An air pump propelled aquarium cleaner to be disposed within an aquarium filled with water and connected to an air pump to clean a bottom of the aquarium, the air pump propelled aquarium cleaner comprising:
a main body;
first tracks movably disposed at a first lateral side of the main body;
second tracks movably disposed at a second lateral side of the main body;
an air receiving tube connected to the main body to receive air from the air pump;
an air driven motor connected to the air receiving tube to receive the air therein, the air driven motor comprising:
a driving axle connected to the air driven motor to rotate in response to the air driven motor receiving the air from the air receiving tube, and
a first driving sprocket disposed at a first end of the driving axle to rotate in response to the rotation of the driving axle, such that the rotation of the driving axle causes the first tracks to move around the first lateral side of the main body,
a second driving sprocket disposed at a second end of the driving axle to rotate in response to the rotation of the driving axle, such that the rotation of the driving axle causes the second tracks to move around the second lateral side of the main body; and
a fan pump to receive the air from the air receiving tube, the fan pump comprising:
a fan disposed at a base portion of the fan pump to rotate in response to receiving the air from the air receiving tube, such that rotation causes debris to be picked up by the fan and directed into the fan pump,
a debris outtake hose connected to a top portion of the fan pump at a first end thereof to receive the debris, and
a debris outtake disposed at a second end of the debris outtake hose to expel the debris onto a surface of the water.

2. The air pump propelled aquarium cleaner of claim 1, further comprising: a plurality of first passive sprockets connected to the first tracks to rotate in response to the movement of the first tracks, such that the plurality of first passive sprockets guide the first tracks around the first lateral side of the main body; and
a plurality of second passive sprockets connected to the second tracks to rotate in response to the movement of the second tracks, such that the plurality of second passive sprockets guide the second tracks around the second lateral side of the main body.
